(19) United States
(12) Patent Application Publication
(10) Pub. No.: US 2002/0196624 A1
(43) Pub. Date: Dec. 26, 2002

(54) ROTARY PATTERNED LAMP

(76) Inventor: Fong-Shi Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/887,351

(22) Filed: Jun. 25, 2001

(51) Int. Cl. F21V 21/30

(52) U.S. Cl. 362/250; 362/35; 362/271; 362/287

(57) ABSTRACT

This invention relates to a rotary patterned lamp, which includes a supporting frame to connect with a rotator. The rotator has a downward link to connect with a patterned lamp having lighting string thereon. The frame is provided with two pins, each of which is contacted with a conductive ring around the rotator and a conductive rod between the frame and the rotator. The two pins are connected with the electrical wire extendedly to the power source to provide the power to light up the bulb of the patterned lamp that obtains a rotary decorative improved lighting effect.

### BACKGROUND OF INVENTION

A prior patterned lamp is usually a fixed decorative structure for being hanged on a supporter or on wall to display a simple unchanged outlook. The only decorative effect is the twinkling of the bulb. It is without utility.

Accordingly, the primary object of the invention is to provide a rotary patterned lamp, which can be rotated to obtain a various decoration while the electrical wire of the patterned lamp will not be winded in disturbance and the electrical conductive connection will be maintained always for the bulb lighting. Now the features and advantages of the invention will be described in detail with reference to the accompanying drawings.

### BRIEF DESCRIPTION OF THE INVENTION

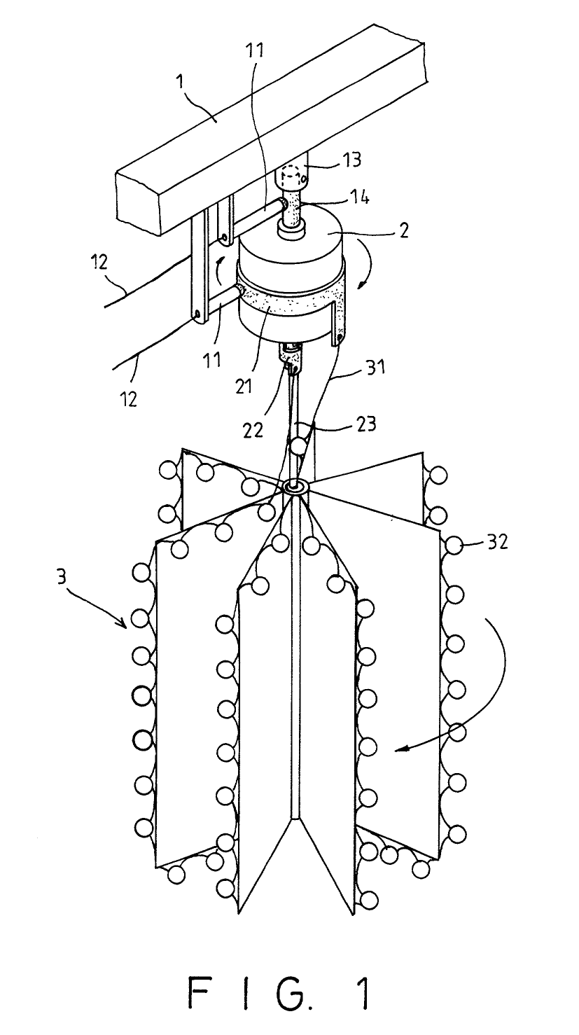

FIG. 1 is a schematic perspective view showing a rotary patterned lamp according to the present invention.

### DETAILED DESCRIPTION OF THE INVENTION

Please refer to FIG. 1, the present invention includes a supporting frame (1) as a main body, which is provided with two lower separated pins (11), each of which is extendedly connected with electrical wire (12) to the power source. A fixed receiver (13) formed under the frame (1) connects with a downward conductive rod (14) to connect with a rotator (2). The rotator (2) has an outer conductive ring (21) and connects with a downward link (23) and a lower conductive slice (22). The two pins (11) are respectively contacting with the conductive rod (14) and the conductive ring (21). Two ends of the electrical wire (31) of a lighting string mounted on the patterned lamp (3) are respectively connected with the conductive ring (21) and the conductive slice (22) being conductively connected with the conductive rod (14).

When the power source is on, the pins (11), the ring (21), the rod (14), and the slice (22) together with the electrical wire (31) are becoming an electrical circuit that provides the bulb (32) on the lamp (3) to light up. While the patterned lamp (3) is lightened, the rotator (2) can be rotated by an inner motor to rotate the lamp (3) at the same time that obtains a rotative decorative effect. Meanwhile, the electrical wire (31) of the patterned lamp (3) will not be winded because of the rotary conductive contact between the pin (11) and the ring (21) and rod (14). The patterned lamp (3) is capable of being rotatory by natural wind when the rotator (2) is free to be rotated while the bulb of the lamp still keeps lightened.

Accordingly, the present invention provides a new assembled structure. It uses a rotary foundation to connect with any kind of patterned lamp, which can be rotated with a various decoration, and keeps the electrical wires without being winded while the bulb being lightened. Evidently it meets the requirements of granting a patent. We hereby file an application for a patent grant.

What is claimed is:

1. A rotary patterned lamp including a supporting frame being provided with two lower separated pins, each of which is extendedly connected with an electrical wire to the power source, a fixed receiver formed under the frame connected with a downward conductive rod to connect with a rotator, which has an outer conductive ring and connects with a downward link and a lower conductive slice; the said two pins being respectively contacting with the conductive rod and the conductive ring, and two ends of the electrical wire of a lighting string mounted on the patterned lamp being respectively connected with the conductive ring and the conductive slice being conductively that becomes an electrical circuit for lighting the bulb of the lamp.

2. The rotary patterned lamp as claimed in claim 1, wherein the link under the rotator is capable of being connected with any kind of the patterned lamp with lighting string.

3. The rotary patterned lamp as claimed in claim 1, wherein the rotator is free to be rotated while the patterned lamp can be rotary by natural wind and maintains the bulb lightened without the electrical wire being winded in disturbance.
